(19) United States
(12) Patent Application Publication
(10) Pub. No.: US 2025/0232890 A1
(43) Pub. Date: Jul. 17, 2025

(54) STRETCHABLE WIRING MATERIAL, AND STRETCHABLE DEVICE

(71) Applicant: TDK CORPORATION, Tokyo (JP)

(72) Inventors: Kazutaka TAMAKI, Tokyo (JP); Hajime AZUMA, Tokyo (JP)

(73) Assignee: TDK CORPORATION, Tokyo (JP)

(21) Appl. No.: 18/849,622

(22) PCT Filed: Aug. 30, 2022
(86) PCT No.: PCT/JP2022/032498

§ 371 Date: Sep. 23, 2024

(30) Foreign Application Priority Data
Mar. 31, 2022 (JP) 2022-060116

(51) Int. Cl. H01B 1/22; C08K 3/08

(52) U.S. Cl. CPC H01B 1/22; C08K 3/08; C08K 2003/0806

(57) ABSTRACT

This stretchable wiring material includes: a resin; and a metal powder, in which an elongation at break is 130% or more, a resistivity (ρ₀) before stretching and contracting is 2×10⁻² [Ωmm] or less, the metal powder includes a scale-shaped powder, and a proportion of the resin is 8 wt % to 20 wt %.

### TECHNICAL FIELD

The present invention relates to a stretchable wiring material and a stretchable device.

Priority is claimed on Japanese Patent Application No. 2022-060116, filed Mar. 31, 2022, the content of which is incorporated herein by reference.

### BACKGROUND ART

In recent years, along with the development of flexible sensors, wearable devices capable of managing physical condition have been attracting attention. Wearable devices are expected to have a wide range of applications in the fields of sports science and healthcare, where they are designed to measure and monitor specific parts of the body such as those directly attached to the skin or those built into clothing. Since human skin is repeatedly stretched and contracted on a daily basis, it is desirable for a wearable device to be stretchable in response to the object on which it is worn if stress-free wearability is desired for the wearable device. In addition, it is desirable that the wearable device have a strength at a certain level or higher against stress generated during its bending and rolling, assuming its handling or human movement. Devices with such a characteristic are referred to as stretchable devices in the present specification, with their use not limited to wearable devices.

Stretchable devices are assumed to include electrodes, wiring, devices, electronic components, thin-film sensors, and the like within stretchable elements, and it is necessary for them to maintain their quality even in a use environment where stretching and contracting are repeated. However, it is difficult to realize such stretchable devices with polyimide sheets used in conventional thin-film resin substrates. For this reason, it is assumed that resins, such as urethane resins, silicone resins, acrylic resins, epoxy resins, polycarbonates, polystyrene, and polyolefins, corresponding to stretchability will be used as main constituent materials for elements and electrodes in stretchable devices. Among these, it is thought that a stretchable film which is a cured product of a composition containing a (meth)acrylate compound with a siloxane bond, a (meth)acrylate compound with a urethane bond other than the (meth)acrylate compound, and an organic solvent with a boiling point in a range of 115° C. to 200° C. at atmospheric pressure and in which the (meth)acrylate compound with a siloxane bond is unevenly distributed on the film surface has excellent stretchability and strength comparable to those of polyurethanes, and the film surface has excellent water repellency comparable to that of silicones (refer to Patent Document 1).

### CITATION LIST

### Patent Document

Patent Document 1: Japanese Unexamined Patent Application, First Publication No. 2017-206626

### SUMMARY OF INVENTION

### Technical Problem

However, in the case of the resin sheet (resin film) made mainly of a cured product of a resin composition as described in Patent Document 1, if the curing reaction does not proceed uniformly, there is a problem that variations in composition and degree of curing may occur in the resin sheet, resulting in the sheet not having desired stretchability, strength, and aging degradation resistance characteristics.

In addition, to realize stretchable devices, wiring with high conductivity and stretchability as well as a small change in conductivity during stretching and contracting is desired.

The present invention has been made in consideration of the above-described circumstances, and an object of the present invention is to provide a stretchable wiring material with high conductivity and high stretchability as well as a small change in conductivity during stretching and contracting, and a stretchable device.

### Solution to Problem

The present invention provides the following means to solve the above-described problem.

Aspect 1 of the present invention is a stretchable wiring material including: a resin; and a metal powder, in which an elongation at break is 130% or more, a resistivity (ρ₀) before stretching and contracting is 2×10⁻² [Ωmm] or less, the metal powder includes a scale-shaped powder, and a proportion of the resin is 8 wt % to 20 wt %.

Aspect 2 of the present invention is a stretchable wiring material including: a resin; and a metal powder, in which an elongation at break is 130% or more, a ratio (ρ₅₀/ρ₀) of a resistivity (ρ₅₀) at 50% elongation to a resistivity (ρ₀) before stretching and contracting is 7 or less, the metal powder includes a scale-shaped powder, and a proportion of the resin is 8 wt % to 20 wt %.

As aspect 3 of the present invention, in the stretchable wiring material according to aspect 2, a ratio (ρ₁₀₀/ρ₅₀) of a resistivity (ρ₁₀₀) at 100% elongation to a resistivity (ρ₅₀) at 50% elongation is 8 or less.

Aspect 4 of the present invention is a stretchable wiring material including: a resin; and a metal powder, in which an elongation at break is 130% or more, a rate of change of a ratio (ρ₁₀₀/ρ₅₀) of a resistivity (ρ₁₀₀) at 100% elongation to a resistivity (ρ₅₀) at 50% elongation with respect to a ratio (ρ₅₀/ρ₀) of a resistivity (ρ₅₀) at 50% elongation to a resistivity (ρ₀) before stretching and contracting is 140% or less, the metal powder includes a scale-shaped powder, and a proportion of the resin is 8 wt % to 20 wt %.

As aspect 5 of the present invention, in the stretchable wiring material according to any one of aspects 1 to 4, the resin is solidified through drying.

As aspect 6 of the present invention, in the stretchable wiring material according to any one of aspects 1 to 5, a proportion of the scale-shaped powder in the metal powder is 2.5 wt % to 50 wt %.

As aspect 7 of the present invention, in the stretchable wiring material according to any one of aspects 1 to 6, an average maximum particle diameter of the scale-shaped powder is 3 μm to 10 μm.

As aspect 8 of the present invention, in the stretchable wiring material according to any one of aspects 1 to 7, the resin includes a urethane resin.

Aspect 9 of the present invention is a stretchable device in which the stretchable wiring material according to any one of aspects 1 to 8 is used.

### Advantageous Effects of Invention

According to the present invention, it is possible to provide a stretchable wiring material with high conductivity and high stretchability as well as a small change in conductivity during stretching and contracting.

### DESCRIPTION OF EMBODIMENTS

Hereinafter, the present invention will be described in detail. Materials, dimensions, and the like exemplified in the following description are merely examples, and the present invention is not limited thereto and can be modified as appropriate within a range in which the gist of the present invention does not change.

### Stretchable Wiring Material (First Embodiment)

A stretchable wiring material of a first embodiment includes: a resin; and a metal powder, in which an elongation at break is 130% or more, a resistivity before stretching and contracting is 2×10⁻³ [Ωmm] or less, the metal powder includes a scale-shaped powder, and a proportion of the resin is 4 wt % to 20 wt %.

### (Resin)

The resin contained in the stretchable wiring material of the first embodiment is not particularly limited, and a well-known one can be used as a resin with stretchability. Examples thereof include urethane resins, acrylic resins, epoxy resins, urea resins, polyurethane urea resins, methacrylic acid resins, polyacrylic resins, silicone resins, diene resins, polyester resins, polyether resins, polyamide resins, polystyrene resins, and polyimide resins. These may be used alone or in combination of two or more thereof.

The above-described resins are preferably soluble in any one or more kinds of solvents selected from diethylene glycol monobutyl ether acetate (BCA), butyl carbitol (BC), ethyl cyanoacrylate (ECA), α-terpineol, diethylene glycol monobutyl ether, and diethylene glycol monoethyl ether acetate.

The stretchable wiring material of the first embodiment can be formed by applying and solidifying a resin composition containing a resin used, a metal powder, and a solvent.

Among the above-described resins, it is preferable to use a dry solidified resin that can be molded and solidified by only applying and drying the resin composition without a curing reaction. Examples of dry solidified resins include urethane resins. In this case, the stretchable wiring material according to the present invention can be referred to as a dry solidified stretchable wiring material.

This is because, with resins that require a curing reaction, if the curing reaction does not proceed uniformly, variations in composition and degree of curing may occur in wiring material sheets, resulting in resins that do not have desired stretchability, strength, and aging degradation resistance characteristics.

In addition, when a urethane resin is used, it is preferable that the resin component have a siloxane bond. This is because in this case, the resin composition has moderate water repellency, which inhibits hydrolysis of urethane bonds.

The proportion of the resin in the stretchable wiring material of the first embodiment is 8 wt % to 20 wt %.

The stretchable wiring material of the first embodiment is a wiring material with a small change in conductivity during stretching and contracting, but the proportion of the resin is 8 wt % or more to ensure high stretchability (high elongation at break) as a precondition for this. On the other hand, the stretchable wiring material of the first embodiment is a wiring material with high conductivity before and during stretching and contracting, but the proportion of the resin is set to 20 wt % or less to ensure high conductivity (low resistivity).

The proportion of the resin in the stretchable wiring material is preferably 10 wt % or more. The proportion of the resin in the stretchable wiring material is preferably 18 wt % or less.

When a urethane resin is contained in the resin in the stretchable wiring material of the first embodiment, the proportion of urethane bonds in the resin is preferably 15 wt % or more, and more preferably 17 wt % or more.

The proportion of urethane bonds in the resin can be calculated, for example, by calculating the peak surface area corresponding to the urethane bonds in the C¹³ nuclear magnetic resonance (NMR) spectrum.

In addition, the elongation at break may be low in examples with a high proportion of urethane bonds in the resin, which will be described below. The reason for this is not clear at present, but based on the examples, the proportion of urethane bonds in the resin is preferably 30 wt % or less, more preferably 25 wt % or less, and still more preferably 22 mol % or less.

### (Metal Powder)

Metal powders are not particularly limited, and those known as metal powders can be used. Examples thereof include a silver (Ag) powder, carbon (C), a copper (Cu) powder, a palladium (Pd) powder, a gold (Au) powder, and a platinum (Pt) powder. Among these, a silver powder or an alloy powder mainly composed of silver is preferable because of its low resistance. Here, the alloy powder mainly composed of silver means that more than 50 wt % of the powder is silver, and the proportion of silver is preferably 70 wt % or more, more preferably 80 wt % or more, and still more preferably 90 wt % or more.

As metal powders, those appropriately produced may be used, or commercially available products may be used.

Examples of methods for producing a silver powder include a method for adding a reducing agent-containing aqueous solution to an aqueous reaction system containing silver ions to reduce and precipitate silver particles. In addition, a silver powder, such as a silver-coated copper powder, which has a silver surface and an interior composed of a metal other than silver may be used.

A metal powder includes a scale-shaped powder. Here, the term “scale-shaped powder” in the present specification refers to a powder (metal powder) with a thickness of 1/10 or less of the maximum particle diameter. Here, the maximum particle diameter of the scale-shaped powder is defined as follows. Each powder particle has different end-to-end lengths depending on directions in a plan view, and the longest of these lengths is taken as a maximum particle diameter. The maximum particle diameter can be determined through optical microscopic observation, scanning electron microscope (SEM) observation (for example, 5000× field of view), or the like.

When a metal powder is scale-shaped, it has top and bottom surfaces that spread in the surface direction, and therefore, the proportion of surface contact between metal powder particles is increased, leading to high conductivity (low resistivity).

In addition, as scale-shaped (flake-shaped) metal powders, those appropriately produced may be used, or commercially available products may be used.

Scale-shaped metal powders can be produced, for example, by preparing a thin film of a desired metal and then finely pulverizing the thin film. Since scale-shaped metal powders are obtained by finely pulverizing thin films through the production method, individual crushed metal pieces are also flattened. The thickness with respect to the particle diameter (that is, the degree of flattening) can be adjusted by adjusting the thickness of the thin films and the degree of fine pulverization.

The proportion of a scale-shaped powder in the metal powder is preferably 2.5 wt % or more, more preferably 5 wt % or more, and still more preferably 7.5 wt % or more. In addition, the proportion of the scale-shaped powder in the metal powder is preferably 50 wt % or less, more preferably 40 wt % or less, still more preferably 30 wt % or less, and still more preferably 25 wt % or less.

From the viewpoint of high conductivity (low resistivity), a higher proportion of the scale-shaped powder in the metal powder is preferable. However, if the proportion thereof is too high, the stretchability will decrease and the elongation at break will decrease. The degree of freedom of movement of the metal powder is necessary for smooth stretching and contracting of the stretchable wiring material, but when the proportion of the scale-shaped powder exceeds 50 wt %, it is thought to be due to the fact that the scale shape itself has a high resistance to movement.

The average maximum particle diameter of the scale-shaped powder is preferably 3 μm to 10 μm.

This is because if the average maximum particle diameter is 3 μm or more, sufficiently high conductivity (low resistivity) due to the effect of surface contact between metal powder particles can be obtained, and if the average maximum particle diameter is 10 μm or less, sufficient stretchability will decrease and the elongation at break will decrease.

### (Elongation at Break)

The elongation at break of the stretchable wiring material is 130% or more. The elongation at break is preferably 150% or more, more preferably 200% or more, still more preferably 250% or more, and still more preferably 300% or more.

The elongation at break of the stretchable wiring material can be increased by increasing the proportion of the resin in the stretchable wiring material, but the increase in proportion of the resin leads to an increase in resistivity. Therefore, the elongation at break is adjusted as appropriate by adjusting the proportion of the resin according to the elongation at break and resistivity required for a stretchable device in which the stretchable wiring material is used.

In the present specification, the term “elongation at break” is defined by {(length at break-length before pulling)/length before pulling}×100. Although the elongation at break can be measured in each of predetermined directions, it is regarded that in the expression “elongation at break of 150% or more” in the present specification, it is defined as the elongation at break in a direction where the elongation at break is greatest. If there is no anisotropy in the elongation at break, the elongation at break will be uniform in all directions, and if the anisotropy in the elongation at break is small, the elongation at break will have values close to each other in any directions.

### (Method for Measuring Elongation at Break)

First, an example of a method for preparing a sample will be described below.

A glass plate with a clean surface is prepared. Subsequently, a PET film is placed on top of the glass plate and the top side is taped. Subsequently, an applicator (for example, YA type, 75 mm, 152 μm, made by Yoshimitsu Seiki) is prepared and set. Subsequently, a stretchable wiring paste in a container is stirred without introducing air. Subsequently, the stretchable wiring paste is applied on the PET film. Subsequently, the applicator is then slid to spread the stretchable wiring paste. Subsequently, after spreading the stretchable wiring paste, the PET film and the glass plate are taped. Subsequently, after allowing it to stand for 3 minutes to 5 minutes, it is placed in a dryer that has been preheated to 90° C. to 100° C. and dried for 1 hour. The above-described process is used to obtain a sheet-like sample of a stretchable wiring material with a thickness of 30 μm to 70 μm. The combined thickness of the PET film and the sheet-like sample of the stretchable wiring material is about 150 μm.

The elongation at break can be measured as follows. Six strip-like measurement samples of 10 mm wide and 30 mm long are cut out from each sheet-like sample of the stretchable wiring material. For each measurement sample, the elongation at break is calculated through a method shown below, and an average value thereof is taken as an elongation at break. A metal substrate is sandwiched between grip portions at the top and bottom of a measuring instrument, and each measurement sample is fixed with double-sided tape so that the measurement site is 10 mm wide and 10 mm long. The measurement sample is then pulled at a tensile speed of 10 mm/min using a tensile tester (for example, product name: Autograph AGS-5kNX, manufactured by Shimadzu Corporation). The length of each measurement sample at break is then measured, and the length before pulling, 10 mm, is subtracted from that length to calculate the elongation at break of each measurement sample. An average value thereof is taken as an elongation at break, and the elongation at break is calculated according to the above-described definition.

### (Resistivity Before Stretching and Contracting)

The resistivity before stretching and contracting (normal resistivity) of the stretchable wiring material is 2×10⁻² [Ωmm] or less. The resistivity thereof is preferably 7×10⁻³ [Ωmm] or less, more preferably 6×10⁻³ [Ωmm] or less, and still more preferably 4×10⁻³ [Ωmm] or less.

The resistivity before stretching and contracting of the stretchable wiring material can be decreased by increasing the proportion of the metal powder in the stretchable wiring material, but the decrease in proportion of the resin in accordance with the increase in proportion of the metal powder leads to a decrease in elongation at break. Therefore, the resistivity before stretching and contracting is adjusted as appropriate by adjusting the proportion of the metal powder according to the elongation at break and resistivity required for a stretchable device in which the stretchable wiring material is used.

### (Method for Measuring Resistance Value and Resistivity)

First, a sheet-like sample of a stretchable wiring material is prepared through the method described above.

The resistivity before stretching and contracting can be measured as follows. Similarly to the measurement of an elongation at break, six strip-like measurement samples of 10 mm wide and 30 mm long are cut out from each sheet-like sample of the stretchable wiring material. A metal substrate is sandwiched between grip portions at the top and bottom of a measuring instrument, and each measurement sample is fixed with double-sided tape so that the measurement site is 10 mm wide and 10 mm long. The resistance value of each measurement sample is measured in this condition. An average value thereof is taken as a resistance value R₀ before stretching and contracting. The resistance value for each elongation is measured each time during stretching while stretching the sample by moving the metal substrate by 1 mm each, and an average value of the six samples is taken as a resistance value R during stretching thereof.

Subsequently, the thickness of each sheet-like sample of the stretchable wiring material is then measured as follows. Each sheet-like sample of the stretchable wiring material is punched out in a circular shape. Subsequently, the sample is placed on a flat table, and a rectangular PET film with one side larger than the diameter of the circular sample is placed on the sample. The thickness of four corners of a rectangular PET film is measured by, for example, Digimicro ZC-101 (manufactured by Nikon Corporation), and an average thereof is taken as a thickness of the PET film. Next, the combined thickness of the sample and the PET film is measured at five points (top, bottom, left, right, and center), and the thickness of the PET film is subtracted from the average thickness to calculate the thickness t of the sample.

Next, the resistivity ρ₀ (=R₀×(cross-sectional area/length)) is calculated from the above-described resistance value R₀ before stretching and contracting and the thickness t, width, and length of the sheet-like sample of the stretchable wiring material.

In addition, similarly, the resistivity ρ (=R×(cross-sectional area/length)) at each elongation is also calculated from the resistance value at each elongation and the thickness t, width, and length of the sheet-like sample of the stretchable wiring material.

In the stretchable wiring material according to the first embodiment, the ratio (ρ₅₀/ρ₀) of a resistivity (ρ₅₀) at 50% elongation to a resistivity (ρ₀) before stretching and contracting is preferably 7 or less, more preferably 6 or less, and still more preferably 5 or less. In addition, the ratio (ρ₁₀₀/ρ₅₀) of a resistivity (ρ₁₀₀) at 100% elongation to a resistivity (ρ₅₀) at 50% elongation is preferably 8 or less, more preferably 7 or less, still more preferably 6 or less, and still more preferably 5 or less.

The ratio (ρ₅₀/ρ₀) of a resistivity (ρ₅₀) at 50% elongation to a resistivity (ρ₀) before stretching and contracting and the ratio (ρ₁₀₀/ρ₅₀) of a resistivity (ρ₁₀₀) at 100% elongation to a resistivity (ρ₅₀) at 50% elongation are both preferably 7 or less, more preferably 6 or less, and still more preferably 5 or less.

In the stretchable wiring material according to the first embodiment, the rate of change of the ratio (ρ₁₀₀/ρ₅₀) of a resistivity (ρ₁₀₀) at 100% elongation to a resistivity (ρ₅₀) at 50% elongation with respect to the ratio (ρ₅₀/ρ₀) of a resistivity (ρ₅₀) at 50% elongation to a resistivity (ρ₀) before stretching and contracting is preferably 140% or less, more preferably 80% or less, still more preferably 70% or less, still more preferably 60% or less, and still more preferably 50% or less.

In the stretchable wiring material according to the first embodiment, it is more preferable that the ratio (ρ₅₀/ρ₀) of a resistivity (ρ₅₀) at 50% elongation to a resistivity (ρ₀) before stretching and contracting and the ratio (ρ₁₀₀/ρ₅₀) of a resistivity (ρ₁₀₀) at 100% elongation to a resistivity (ρ₅₀) at 50% elongation be both 7 or less and that the rate of change of the ratio (ρ₁₀₀/ρ₅₀) of a resistivity (ρ₁₀₀) at 100% elongation to a resistivity (ρ₅₀) at 50% elongation with respect to the ratio (ρ₅₀/ρ₀) of a resistivity (ρ₅₀) at 50% elongation to a resistivity (ρ₀) before stretching and contracting be 140% or less.

### Stretchable Wiring Material (Second Embodiment)

A stretchable wiring material according to a second embodiment includes: a resin; and a metal powder, in which an elongation at break is 130% or more, a ratio (ρ₅₀/ρ₀) of a resistivity (ρ₅₀) at 50% elongation to a resistivity (ρ₀) before stretching and contracting is 7 or less, the metal powder includes a scale-shaped powder, and a proportion of the resin is 8 wt % to 20 wt %. Descriptions of configurations common to the stretchable wiring material according to the first embodiment will not be repeated.

Furthermore, the ratio (ρ₁₀₀/ρ₅₀) of a resistivity (ρ₁₀₀) at 100% elongation to a resistivity (ρ₅₀) at 50% elongation is preferably 8 or less.

In addition, the proportion of the resin in the stretchable wiring material is preferably 10 wt % or more. The proportion of the resin in the stretchable wiring material is preferably 18 wt % or less.

The smaller the change in resistivity when the stretchable wiring material is stretched, the more preferable it is.

The ratio (ρ₅₀/ρ₀) of a resistivity at 50% elongation to a resistivity before stretching and contracting is preferably 6 or less and more preferably 5 or less. In addition, the ratio (ρ₁₀₀/ρ₅₀) of a resistivity (ρ₁₀₀) at 100% elongation to a resistivity (ρ₅₀) at 50% elongation is more preferably 7 or less, still more preferably 6 or less, and still more preferably 5 or less.

In the stretchable wiring material according to the second embodiment, the rate of change of the ratio (ρ₁₀₀/ρ₅₀) of a resistivity (ρ₁₀₀) at 100% elongation to a resistivity (ρ₅₀) at 50% elongation with respect to the ratio (ρ₅₀/ρ₀) of a resistivity (ρ₅₀) at 50% elongation to a resistivity (ρ₀) before stretching and contracting is preferably 140% or less.

### Stretchable Wiring Material (Third Embodiment)

A stretchable wiring material of a third embodiment includes: a resin; and a metal powder, in which an elongation at break is 130% or more, a rate of change of a ratio (ρ₁₀₀/ρ₅₀) of a resistivity (ρ₁₀₀) at 100% elongation to a resistivity (ρ₅₀) at 50% elongation with respect to a ratio (ρ₅₀/ρ₀) of a resistivity (ρ₅₀) at 50% elongation to a resistivity (ρ₀) before stretching and contracting is 140% or less, the metal powder includes a scale-shaped powder, and a proportion of the resin is 8 wt % to 20 wt %. Descriptions of configurations common to the stretchable wiring material according to the first embodiment will not be repeated.

In addition, the proportion of the resin in the stretchable wiring material is preferably 10 wt % or more. The proportion of the resin in the stretchable wiring material is preferably 18 wt % or less.

Although the resistivity of stretchable wiring material decreases as it stretches, the smaller the proportion of the decrease, the more preferable it is. The rate of change (ratio (ρ₁₀₀/ρ₅₀)/ratio (ρ₅₀/ρ₀)) is preferably 80% or less, more preferably 70% or less, still more preferably 60% or less, and still more preferably 50% or less.

### (Method for Producing Stretchable Wiring Material)

The stretchable wiring materials of the first to third embodiments can be produced through main steps: a (1) stretchable wiring paste production step; a (2) stretchable wiring paste application step; and a (3) drying and solidifying step.

In other words, in the (1) stretchable wiring paste production step, a metal powder is incorporated into a resin composition containing the above-described resin and solvent to produce a stretchable wiring paste. Subsequently, in the (2) stretchable wiring paste application step, the stretchable wiring paste is applied onto a base material (for example, a PET film). Thereafter, in the (3) drying and solidifying step, a stretchable wiring material can be produced by removing the solvent and drying and solidifying the stretchable wiring paste.

Hereinafter, the characteristics of the stretchable wiring material will be described while giving specific examples of resin compositions (resins and solvents) for producing stretchable wiring materials.

Specific examples thereof include a resin composition containing a resin component (in the present specification, sometimes referred to as “resin component (II)”) having a urethane bond and a group represented by General Formulae (11), (21), or (31) below.

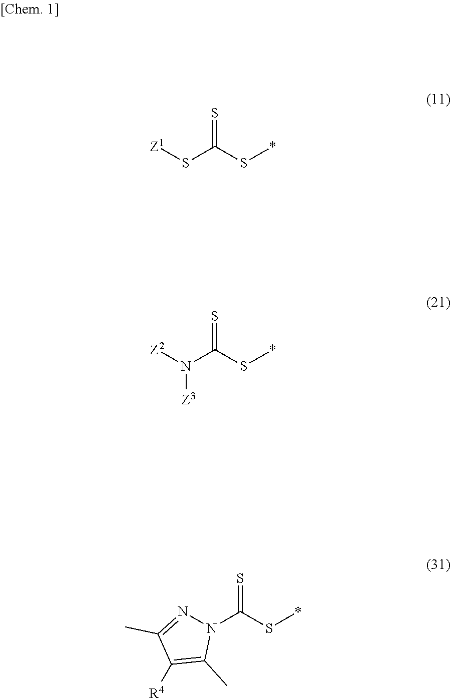

(In the formula, Z1 is an alkyl group, and one or more hydrogen atoms in the alkyl group may be substituted with a cyano group, a carboxy group or a methoxycarbonyl group, and two or more of the substituents may be the same as or different from each other. Z2 is an alkyl group. Z3 is an aryl group. R4 is a hydrogen atom or a halogen atom. A bond marked with a sign * is formed at a bonding destination in the group represented by General Formulae (11), (21), or (31) above.)

The resin component (II) contained in this resin composition is highly flexible because it has a urethane bond.

In addition, the resin component (II) is obtained through a polymerization reaction using a resin having a urethane bond and a polymerizable unsaturated bond and a RAFT agent for performing reversible addition fragmentation chain transfer polymerization (abbreviated as “RAFT polymerization” in the present specification) from which the group represented by General Formulae (11), (21), or (31) above is derived. By conducting the polymerization reaction in this way, gelation of the resin during polymerization in the process of forming a cross-linked structure is avoided, and resin components with the desired degree of polymerization and cross-linked state are obtained. In other words, the resin component (II) having the group represented by General Formulae (11), (21), or (31) above has a small variation in terms of the degree of polymerization and the cross-linked state.

In addition, the resin component (II) may have a siloxane bond, in which case the resin composition has moderate water repellency, which inhibits hydrolysis of urethane bonds in the resin component (II). Such a resin component (II) is obtained through a further polymerization reaction using a resin having a siloxane bond and a polymerizable unsaturated bond.

The method for producing the resin component (II) in which the RAFT polymerization is performed will be described separately in detail.

The resin having a urethane bond and a polymerizable unsaturated bond used in the production of the resin component (II) is an oligomer and may be referred to as “resin (a).”

In addition, the resin having a siloxane bond and a polymerizable unsaturated bond used in the production of the resin component (II) is an oligomer and may be referred to as “resin (b)” in the present embodiment.

The resin component (II) is a polymer formed through polymerization of resins (a) at their polymerizable unsaturated bonds. When the resin (b) is used, the resin component (II) is a polymer formed through polymerization of the resin (a) and the resin (b) at their polymerizable unsaturated bonds.

When the resin (b) is used, the resin component (II) preferably has both urethane and siloxane bonds in one molecule thereof.

The resin (a) is not particularly limited as long as it has a urethane bond and a polymerizable unsaturated bond.

Examples of the resin (a) includes those having a (meth)acryloyl group as a group having a urethane bond and a polymerizable unsaturated bond, and more specific examples thereof include urethane (meth)acrylate.

In the present specification, “(meth)acrylate” is a concept that encompasses both “acrylate” and “methacrylate.” The same applies to terms similar to (meth)acrylate. For example, “(meth)acryloyl group” is a concept that encompasses both “acryloyl group” and “methacryloyl group.”

The resin (b) is not particularly limited as long as it has a siloxane bond and a polymerizable unsaturated bond.

Examples of the resin (b) include various well-known silicone resins having a (meth)acryloyl group as a group having a polymerizable unsaturated bond, and more specific examples thereof include a modified polydialkylsiloxane in which a (meth)acryloyl group is bound to a single terminal or both terminals of polydialkylsiloxane such as polydimethylsiloxane.

The resin component (II) has high solubility in solvents due to its composition. Therefore, the resin composition containing the resin component (II) also has high solubility in solvents.

Such a resin composition having high solubility can easily form a resin composition layer through printing on an object to be applied, for example, through various printing methods. This resin composition layer can then be solidified through drying, without curing, to produce a layer (resin layer, wiring material sheet) similar to the wiring material sheets. Such a technique is suitable for forming electrodes or wiring using the resin composition containing conductive components.

Such a resin composition having high solubility is used to form a stretchable wiring material sheet, and a stretchable device composed of this wiring material sheet has the great advantage of suppressing damage during its stretching and contracting.

Factors that can cause damage to normal stretchable devices during stretching and contracting, from the viewpoint of materials, include (i) interface delamination and structural defects such as voids caused by contraction due to heat or curing reactions, (ii) uneven hardness caused by uneven composition, and (iii) degradation of materials over time caused by light exposure, oxidation, and the like.

Therefore, structural defects such as voids, and interface delamination, uneven composition, and degradation of materials over time can be suppressed, thereby preventing damage to the stretchable devices during stretching and contracting.

Although molding by thermal melting and cross-linking by thermosetting or photocuring reactions are commonly used to process stretchable base materials, there is a concern that the reliability of the stretchable devices will be lowered if even micromachining is considered due to the reasons (i) to (iii). In contrast, for example, if there is a resin that can be molded only through applying and drying a resin composition in response to a lamination process, it is expected that favorable results can be obtained.

As a stretchable wiring material, a wiring material sheet-like stretchable wiring material (hereinafter sometimes referred to as “wiring material sheet”) is obtained by incorporating a metal powder into the resin composition of the above-described specific example to produce a stretchable wiring paste, applying the stretchable wiring paste to a base material, and then solidifying it through drying. A plurality of wiring material sheets may be laminated to produce a stretchable wiring material.

The wiring material sheet has favorable stretchability because it contains the resin component (II) as its main component. When the resin (b) is used, the wiring material sheet further has moderate water repellency, which suppresses degradation over time caused by hydrolysis. The wiring material sheet with such characteristics is particularly suitable for constructing various types of stretchable devices including wearable devices.

The wiring material sheet can be formed simply by solidifying the resin composition through drying, as described above, without any curing reaction. Therefore, it does not have the defects associated with performing a curing reaction.

For example, a photocuring reaction is significantly difficult to uniformly cure materials that do not transmit ultraviolet light. For example, when the periphery of a mounted device or electronic components is irradiated with ultraviolet light, the degree of curing may vary in some areas in a photocurable wiring material sheet due to variations in ultraviolet light transmission, and the wiring material sheet is easily damaged in areas with low cross-linking density. In addition, non-cross-linked areas are easily degraded by oxidation.

On the other hand, a thermosetting reaction easily causes contraction differences in the wiring material sheet due to heat distribution during curing. When such contraction differences occur, different constituent materials among devices, sealants, and the like are easily delaminated at these interfaces. In addition, if areas with different degrees of curing are created in the wiring material sheet due to heat distribution, the sheet will be easily degraded due to repeated stretching and contracting.

Furthermore, in both cases of photocuring and thermosetting reactions, it is difficult for the reactions to progress uniformly in the wiring material sheet. In such cases, variations in composition and degree of curing occur in the wiring material sheet, and the cured wiring material sheet does not have desired stretchability and strength. In addition, because a curing agent is incorporated, degradation over time due to heat or light easily occurs.

In contrast, the wiring material sheet obtained by solidifying the stretchable wiring paste containing the resin composition of the above-described specific example through drying does not have such defects.

The wiring material sheet can be produced without a curing reaction by, for example, applying the stretchable wiring paste to a desired site and solidifying it through drying.

The stretchable wiring paste can be applied, for example, through well-known methods using various coaters, wire bars, or the like, or through various printing methods including inkjet printing methods.

During the production of the wiring material sheet, the drying temperature of the stretchable wiring paste is preferably 25° C. to 150° C. and more preferably 25° C. to 120° C. When the drying temperature is 25° C. or higher, it is possible to more efficiently produce a wiring material sheet. When the drying temperature is 150° C. or lower, the drying temperature is suppressed from becoming excessively high, deformation of a release sheet and damage to the wiring material sheet are less likely to occur, and deterioration of the wiring material sheet is suppressed.

The drying time of the stretchable wiring paste during the production of the wiring material sheet may be set appropriately according to the drying temperature, but is preferably 10 minutes to 120 minutes and more preferably 30 minutes to 90 minutes. When the drying time is within these ranges, wiring material sheets with favorable characteristics can be efficiently produced.

Completion of solidification of the stretchable wiring paste through drying (formation of the wiring material sheet) can be confirmed, for example, by the fact that no clear change in mass of the resin composition being subjected to drying can be observed.

The thickness of the stretchable wiring material is not particularly limited, but can be, for example, 10 μm to 5,000 μm.

### (Use)

The stretchable wiring material according to the present invention can be used as, for example, wiring in stretchable devices. Stretchable devices include so-called stretchable devices regardless of whether or not these are put into practical use.

### EXAMPLES

Hereinafter, the present invention will be described in more detail using specific examples. However, the present invention is not limited to the examples shown below.

Raw materials used in preparation of a stretchable wiring paste are shown below.
Resin (a)
(a)-1: Urethane acrylate oligomer (product name: UN-5500, manufactured by Negami Chemical Industrial Co., Ltd.)
Resin (b)
(b)-1: Methacrylate-modified polydimethylsiloxane modified with a methacryloyl group at a single terminal (product name: Silaplane (registered trademark) FM-0721, manufactured by JNC Corporation)
Polymerization initiator (c)
(c)-1: Dimethyl 2,2′-azobis (2-methylpropionate), azo polymerization initiator (product name: V601, manufactured by FUJIFILM Wako Pure Chemical Corporation)
RAFT agent
(1)-1: RAFT agent represented by Formula (1)-1 below (manufactured by FUJIFILM Wako Pure Chemical Corporation)
(3)-1: RAFT agent represented by Formula (3)-1 below (manufactured by FUJIFILM Wako Pure Chemical Corporation)
Other polymerizable components
MMA: Methyl methacrylate
Solvent
BCA: Butyl carbitol acetate
Metal powder
Silver powder (proportion of scale-shaped powder: 12.5 [wt %], average maximum particle diameter: 3 μm)

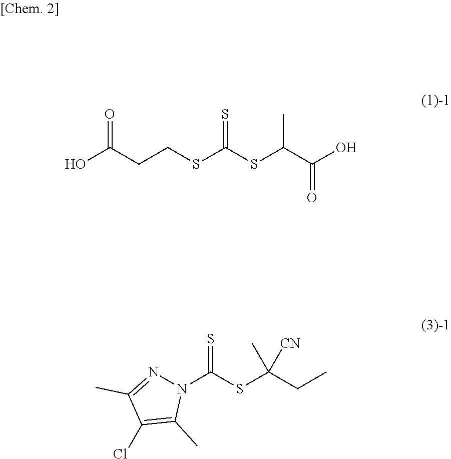 [SMILES: CC(SC(=S)SCCC(=O)O)C(=O)O ; CCC(C)(C#N)SC(=S)n1nc(C)c(Cl)c1C]

### Example 1

A resin (a)-1, a polymerization initiator (c)-1, a RAFT agent (1)-1, a silver powder, and BCA were weighed out in a flask and mixed together using a stirrer at normal temperature to obtain a stretchable wiring paste.

The formulation amounts of resin (b), polymerization initiator (c), and RAFT agent were determined so that the proportion of urethane bonds in the resins in the resulting stretchable wiring material was 20 wt % based on 100 parts by mass of the resin (a). In addition, the formulation amount of silver powder was determined so that the proportion of the resins in the resulting stretchable wiring material was 5 wt %. In other words, the formulation amount of silver powder was determined so that the proportion of the resins to the silver powder was 8 wt %:92 wt %.

Subsequently, sheet-like samples of stretchable wiring materials were prepared through the above-described method, and an elongation at break, a resistivity (ρ₀) before stretching and contracting, a resistivity (ρ₅₀) at 50% elongation, and a resistivity (ρ₁₀₀) at 100% elongation were measured. The obtained results are shown in Table 1.

TABLE 1

| | Resin | | | | Resistivity | | | Rate of |
|---|---|---|---|---|---|---|---|---|
| | Proportion | Proportion | Metal powder | | (Rdc) before | | | change of |
| | of resin in | of urethane | Proportion of | | stretching | | | (ρ₅₀/ρ₀) with |
| | wiring | bond | scale-shaped | Elongation | and | | | respect to |
| | material | in resin | powder | at | contracting | | | (ρ₅₀/ρ₀) |
| | [wt %] | [t %] | [wt %] | break [%] | [Ω cm] | ρ₅₀/ρ₀ | ρ₁₀₀/ρ₅₀ | (%) |
| Comparative | 6 | 20 | 12.5 | 5.3 | 8.60*10\hat{ }(−3) | — | — | — |
| Example 1 | | | | | | | | |
| Example 1 | 8 | 20 | 12.5 | 130.0 | 2.81*10\hat{ }(−3) | 5.3 | 8.0 | 51% |
| Example 2 | 10 | 20 | 12.5 | 165.3 | 4.28*10\hat{ }(−3) | 4.0 | 4.5 | 13% |
| Example 3 | 15 | 20 | 12.5 | 322.1 | 4.64*10\hat{ }(−3) | 5.3 | 5.4 | 0% |
| Example 4 | 18 | 20 | 12.5 | 370.8 | 3.00*10\hat{ }(−3) | 2.9 | 5.2 | 82% |
| Example 5 | 20 | 20 | 12.5 | 414.9 | 1.53*10\hat{ }(−2) | 1.7 | 4.0 | 133% |
| Comparative | 22 | 20 | 12.5 | 482 | 2.89*10\hat{ }(−1) | 0.012 | 4.4 | 36030% |
| Example 2 | | | | | | | | |
| Comparative | 15 | 0 | 12.5 | 6.0 | 3.59*10\hat{ }(−1) | — | — | — |
| Example 3 | | | | | | | | |
| Comparative | 15 | 10 | 12.5 | 7.0 | 1.13*10\hat{ }(−2) | — | — | — |
| Example 4 | | | | | | | | |
| Comparative | 15 | 15 | 12.5 | 37.4 | 6.48*10\hat{ }(−3) | — | — | — |
| Example 5 | | | | | | | | |
| Example 6 | 15 | 17.5 | 12.5 | 172.3 | 7.34*10\hat{ }(−3) | 3.3 | 4.1 | 25% |
| Example 3 | 15 | 20 | 12.5 | 322.1 | 4.64*10\hat{ }(−3) | 5.3 | 5.4 | 0% |
| Example 7 | 15 | 22 | 12.5 | 297.1 | 6.61*10\hat{ }(−3) | 5.0 | 5.35 | 7% |
| Example 8 | 15 | 25 | 12.5 | 245.5 | 4.75*10\hat{ }(−3) | 2.8 | 4.9 | 75% |
| Example 9 | 15 | 30 | 12.5 | 130.4 | 3.29*10\hat{ }(−3) | 5.0 | — | — |
| Comparative | 15 | 30 | 0 | 47.2 | 4.71*10\hat{ }(−1) | | | |
| Example 6 | | | | | | | | |
| Comparative | 15 | 30 | 12.5 | 8.9 | 1.93*10\hat{ }(−3) | — | — | — |
| Example 7 | | | | | | | | |
| Example 10 | 15 | 20 | 2.5 | 322.1 | 4.72*10\hat{ }(−3) | 3.3 | 4.2 | 27% |
| Example 11 | 15 | 20 | 7.5 | 275.9 | 4.77*10\hat{ }(−3) | 2.8 | 3.9 | 42% |
| Example 3 | 15 | 20 | 12.5 | 322.1 | 4.64*10\hat{ }(−3) | 5.3 | 5.4 | 0% |
| Example 12 | 15 | 20 | 30 | 300 | 4.76*10\hat{ }(−3) | 4.0 | 6.9 | 73% |
| Example 13 | 15 | 20 | 40 | 230.5 | 5.62*10\hat{ }(−3) | 2.2 | 5.10 | 131% |
| Example 14 | 15 | 20 | 50 | 169.3 | 2.66*10\hat{ }(−3) | 51 | — | — |

### Examples 2 to 5 and Comparative Examples 1 and 2

For Examples 2 to 5 and Comparative Examples 1 and 2, sheet-like samples of stretchable wiring materials were prepared in the same manner as in Example 1 except that the formulation amount of silver powder was adjusted so that the proportion of resins in each resulting stretchable wiring material was 10 wt %, 15 wt %, 18 wt %, 20 wt %, 6 wt %, and 22 wt %. The same characteristics were measured on the resulting samples. The results are shown in Table 1.

### Examples 6 to 9 and Comparative Examples 3 to 5

For all of Examples 6 to 9 and Comparative Examples 3 to 5, sheet-like samples of stretchable wiring materials were prepared in the same manner as in Example 1 except that the formulation amount was adjusted so that the proportion of resins in each resulting stretchable wiring material was 15 wt % and the proportion of urethane bonds in the resins in each resulting stretchable wiring material was 17.5 wt %, 20 wt %, 22 wt %, 25 wt %, 30 wt %, 0 wt %, 10 wt %, and 15 wt %. The same characteristics were measured on the resulting samples. The results are shown in Table 1.

### Comparative Examples 6 and 7

Comparative Examples 6 and 7 are those in which each stretchable wiring paste was applied and then subjected to a curing reaction instead of drying and solidifying. In Comparative Example 6, a stretchable wiring paste was obtained in the same manner as in Comparative Example 5 except that a silver powder did not have a scale shape. In Comparative Example 7, the same stretchable wiring paste as in Example 9 was used. The same characteristics were measured on the resulting samples. The results are shown in Table 1.

### Examples 10 to 16

For all of Examples 10 to 16, sheet-like samples of stretchable wiring materials were prepared in the same manner as in Example 1 except that the proportion of resins in each resulting stretchable wiring material was 15 wt %, the proportion of urethane bonds in the resins in each resulting stretchable wiring material was 20 mol %, and a silver powder in which the proportion of each scale-shaped powder was 2.5 wt %, 7.5 wt %, 12.5 wt %, 30 wt %, 40 wt %, and 50 wt % was used.

The same characteristics were measured on the resulting samples. The results are shown in Table 1.

Findings obtained from the results of Table 1 will be shown. Values not included in Table 1 are those that could not be measured or were not measured.

Examples 1 to 6 and Comparative Examples 1 and 2 will be compared with each other. When the proportion of urethane bonds in resins and the proportion of a scale-shaped powder were fixed to the proportions shown in Table 1, the following findings were obtained.

When the proportion of resins in a wiring material was 8 wt % (resin: silver powder=8:92) or more, the elongation at break was 130% or more, and the higher the proportion of the resins, the higher the elongation at break was obtained. On the other hand, when the proportion of resins was 20 wt % or more, the resistivity before stretching and contracting was 1×10⁻² [Ωcm] or more. From the viewpoint of achieving both a higher elongation at break (150% or more) and a lower resistivity before stretching and contracting (5×10⁻³ [Ωcm] or less), the proportion of resins in a wiring material is preferably 10 wt % to 18 wt %.

In addition, when the proportion of resins was 20 wt % (resin: silver powder=20:80) (Example 5), the resistivity before stretching and contracting was 1.53×10⁻² [Ωcm] which was slightly high. However, reflecting its high elongation at break, the ratio (ρ₅₀/ρ₀) of a resistivity (ρ₅₀) at 50% elongation to a resistivity (ρ₀) before stretching and contracting was 1.7 which was a low rate of change and the ratio (ρ₁₀₀/ρ₅₀) of a resistivity (ρ₁₀₀) at 100% elongation to a resistivity (ρ₅₀) at 50% elongation was 4.0 which was a sufficiently low rate of change. From the viewpoint of achieving both the high elongation at break (150% or more) and low ratios (ρ₅₀/ρ₀) and (ρ₁₀₀/ρ₅₀), the proportion of resins in a wiring material is preferably 10 wt % to 20 wt %.

In addition, from the viewpoint of achieving both the high elongation at break (150% or more) and a low rate of change of the ratio (ρ₁₀₀/ρ₅₀) to the ratio (ρ₅₀/ρ₀), the proportion of resins in a wiring material is preferably 10 wt % to 15 wt %.

Furthermore, from the viewpoint of satisfying all of the high elongation at break (150% or more), the low resistivity before stretching and contracting, the low ratios (ρ₅₀/ρ₀) and (ρ₁₀₀/ρ₅₀), and the low rate of change of the ratio (ρ₁₀₀/ρ₅₀) to the ratio (ρ₅₀/ρ₀), the proportion of resins in a wiring material is preferably 10 wt % to 15 wt %.

Next, Examples 3, 6 to 9 and Comparative Examples 3 and 4 will be compared with each other. When the proportion of resins in a wiring material and the proportion of a scale-shaped powder were fixed to the proportions shown in Table 1, the following findings were obtained.

When the proportion of urethane bonds in resins was 15 wt % or less, the elongation at break was 40% or less. On the other hand, when the proportion of urethane bonds was 25 wt % (Example 8), the elongation at break was 245.5%, but when the proportion thereof was 30 wt % (Example 9), the elongation at break was 130.4%. From the viewpoint of a high elongation at break (150% or more), the proportion of urethane bonds in resins is preferably 17.5 wt % to 25 wt %. In addition, from the viewpoint of achieving both a higher elongation at break (150% or more) and a lower resistivity before stretching and contracting (7×10⁻³ [Ωcm] or less), the proportion of urethane bonds in resins is preferably 20 wt % to 25 wt %.

In addition, from the viewpoint of achieving both the high elongation at break (150% or more) and low ratios (ρ₅₀/ρ₀) and (ρ₁₀₀/ρ₅₀), the proportion of urethane bonds in resins is preferably 17.5 wt % to 25 wt %.

In addition, from the viewpoint of achieving both the high elongation at break (150% or more) and a low rate of change of the ratio (ρ₁₀₀/ρ₅₀) to the ratio (ρ₅₀/ρ₀), the proportion of urethane bonds in resins is preferably 17.5 wt % to 22 wt %.

Furthermore, from the viewpoint of satisfying all of the high elongation at break (150% or more), the low resistivity before stretching and contracting, the low ratios (ρ₅₀/ρ₀) and (ρ₁₀₀/ρ₅₀), and the low rate of change of the ratio (ρ₁₀₀/ρ₅₀) to the ratio (ρ₅₀/ρ₀), the proportion of urethane bonds in resins is preferably 17.5 wt % to 22 wt %.

In Comparative Examples 6 and 7, each stretchable wiring paste was applied and then subjected to a curing reaction instead of drying and solidifying. However, the resistivity before stretching and contracting in Comparative Example 6 in which a silver powder did not have a scale shape was about 5×10⁻¹ [Ωcm] which was considerably high, and the elongation at break in Comparative Example 7 of which the composition of the stretchable wiring paste itself was the same as that of Example 9 was 10% or less. Therefore, it was found that Comparative Examples 6 and 7 were not suitable for application to stretchable devices.

Next, Examples 3, 10 to 14 were compared with each other. When the proportion of resins in a wiring material and the proportion of urethane bonds in the resins were fixed to the proportions shown in Table 1, the following findings were obtained.

As the proportion of a scale-shaped powder in a silver powder was 40 wt % or 50 wt %, the elongation at break was negatively affected and gradually decreased. Furthermore, at 40 wt % (Example 13), the rate of change of the ratio (ρ₁₀₀/ρ₅₀) to the (ρ₅₀/ρ₀) increased to 130% or more, and at 50 wt % (Example 14), the ratio (ρ₅₀/ρ₀) was 51 times greater.

From a viewpoint, when the proportion of a scale-shaped powder in a silver powder is within a range of 2.5 wt % to 50 wt %, it is possible to achieve both a higher elongation at break (150% or more) and a lower resistivity before stretching and contracting 7×10⁻³ [Ωcm] or less).

From the viewpoint of achieving both the high elongation at break (150% or more) and low ratios (ρ₅₀/ρ₀) and (ρ₁₀₀/ρ₅₀), the proportion of a scale-shaped powder in a silver powder is preferably 2.5 wt % to 40 wt %.

In addition, from the viewpoint of achieving both the high elongation at break (150% or more) and a low rate of change of the ratio (ρ₁₀₀/ρ₅₀) to the ratio (ρ₅₀/ρ₀), the proportion of a scale-shaped powder in a silver powder is preferably 2.5 wt % to 12.5 wt %.

Furthermore, from the viewpoint of satisfying all of the high elongation at break (150% or more), the low resistivity before stretching and contracting, the low ratios (ρ₅₀/ρ₀) and (ρ₁₀₀/ρ₅₀), and the low rate of change of the ratio (ρ₁₀₀/ρ₅₀) to the ratio (ρ₅₀/ρ₀), the proportion of a scale-shaped powder in a silver powder is preferably 2.5 wt % to 12.5 wt %.

High flexibility is obtained by containing urethane bonds in resins. In addition, when resins contain either urethane bonds or siloxane bonds, both high stretchability and low resistivity can be achieved through an effect of improving dispersion and aggregation of a silver powder. Furthermore, when both the urethane bonds and the siloxane bonds are contained, a higher improvement effect is obtained.

1. A stretchable wiring material comprising:
a resin; and
a metal powder,
wherein an elongation at break is 130% or more,
wherein a resistivity (ρ₀) before stretching and contracting is 2×10⁻² [Ωmm] or less,
wherein the metal powder includes a scale-shaped powder, and
wherein a proportion of the resin is 8 wt % to 20 wt %.

2. A stretchable wiring material comprising:
a resin; and
a metal powder,
wherein an elongation at break is 130% or more,
wherein a ratio (ρ₅₀/ρ₀) of a resistivity (ρ₅₀) at 50% elongation to a resistivity (ρ₀) before stretching and contracting is 7 or less,
wherein the metal powder includes a scale-shaped powder, and
wherein a proportion of the resin is 8 wt % to 20 wt %.

3. The stretchable wiring material according to claim 2,
wherein a ratio (ρ₁₀₀/ρ₅₀) of a resistivity (ρ₁₀₀) at 100% elongation to a resistivity (ρ₅₀) at 50% elongation is 8 or less.

4. A stretchable wiring material comprising:
a resin; and
a metal powder,
wherein elongation at break is 130% or more,
wherein a rate of change of a ratio (ρ₁₀₀/ρ₅₀) of a resistivity (ρ₁₀₀) at 100% elongation to a resistivity (ρ₅₀) at 50% elongation with respect to a ratio (ρ₅₀/ρ₀) of a resistivity (ρ₅₀) at 50% elongation to a resistivity (ρ₀) before stretching and contracting is 140% or less,
wherein the metal powder includes a scale-shaped powder, and
wherein a proportion of the resin is 8 wt % to 20 wt %.

5. The stretchable wiring material according to claim 1,
wherein the resin is solidified through drying.

6. The stretchable wiring material according to claim 1,
wherein a proportion of the scale-shaped powder in the metal powder is 2.5 wt % to 50 wt %.

7. The stretchable wiring material according to claim 1,
wherein an average maximum particle diameter of the scale-shaped powder is 3 μm to 10 μm.

8. The stretchable wiring material according to claim 1,
wherein the resin includes a urethane resin.

9. A stretchable device in which the stretchable wiring material according to claim 1 is used.

10. The stretchable wiring material according to claim 2, wherein the resin includes a urethane resin.

11. The stretchable wiring material according to claim 4, wherein the resin includes a urethane resin.

12. A stretchable device in which the stretchable wiring material according to claim 2 is used.

13. A stretchable device in which the stretchable wiring material according to claim 3 is used.

14. A stretchable device in which the stretchable wiring material according to claim 4 is used.

15. A stretchable device in which the stretchable wiring material according to claim 5 is used.

16. A stretchable device in which the stretchable wiring material according to claim 6 is used.

17. A stretchable device in which the stretchable wiring material according to claim 7 is used.

18. A stretchable device in which the stretchable wiring material according to claim 10 is used.

19. A stretchable device in which the stretchable wiring material according to claim 11 is used.
